(19) United States
(12) Patent Application Publication
(10) Pub. No.: US 2005/0165862 A1
(43) Pub. Date: Jul. 28, 2005

(54) Autonomic and fully recovering filesystem operations

(75) Inventors: Zachary Merlynn Loafman, Austin, TX (US); Grover Herbert Neuman, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/755,836

(22) Filed: Jan. 12, 2004

(51) Int. Cl. G06F 17/30

(52) U.S. Cl. 707/202

(57) ABSTRACT

A filesystem operation binds “undo” information to given filesystem resources, in order for the filesystem operation to reverse or rollback changes made to the resources, and thereby return a filesystem affected by a failed or incomplete operation from an inconsistent state to a previous, consistent state. Changes can be undone, to return the filesystem to a consistent state, as long as any further changes can also be undone successfully. Latter changes can be undone by making sure that no operation is fully successful until the preceding operations that changed the same metadata are successful. In an error path, the operation can go through every resource modified to determine if other threads have modified data beyond the initial modification. A failing thread can notify later threads that an operation has failed and all changes are to be undone. Each thread can then run through and undo all pertinent metadata changes that were made.

### RELATED APPLICATIONS

The present application is related to commonly assigned and co-pending U.S. patent application Ser. No. ______ (Attorney Docket No. AUS920030646US1) entitled “AUTONOMIC FILESYSTEM RECOVERY”, filed on Oct. 30, 2003, and hereby incorporated by reference.

### BACKGROUND OF THE INVENTION

1. Technical Field

The invention relates to the autonomic recovery of filesystem operations. More specifically, the present invention provides an improved method, apparatus and program for recovering a filesystem in an inconsistent state and returning the filesystem to a consistent state.

2. Description of Related Art

A filesystem is a file management system that an Operating System (OS) or other program can use to organize and monitor files. Currently, when a filesystem operation fails during the course of the operation, the OS (or other program) performing the filesystem operation typically aborts the operation, marks the filesystem as “dirty,” notifies the user of the failed operation, and utilizes another program or process to correct the error. For example, the OS can use a filesystem error correction program, such as a filesystem checker (fsck), to repair the “dirty” filesystem.

Essentially, when a conventional filesystem operation needs to change a series of metadata resources, the filesystem typically acquires an exclusive “lock” on a resource, changes the data for that resource, and then drops the “lock” on that resource. Under certain conditions, the filesystem can “lock” multiple resources at once, but these operations are coded carefully to avoid a “deadlock”. An example of the flow of such an occurrence in a conventional, single thread filesystem operation is shown in FIG. 1.

As depicted in FIG. 1, in the filesystem operation, the OS (or other program) updates an inode (step 102). An “inode” is a data structure (e.g., data file) that contains certain information about files, in particular, in UNIX filesystems. Each such file has an inode that is identified by an inode number in the filesystem where that file resides. An inode provides pertinent information about that file, such as, for example, user ownership, access mode, time stamps and file type (e.g., regular file, directory file, etc.). An inode is created when the corresponding filesystem is created.

Next, the OS (or other program) updates a directory associated with that file (step 104). The directory contains information about the files that lie beneath the directory in a hierarchical structure. For example, the hierarchical structure can be in the form of an inverted tree. An assumption is made that an error in the filesystem operation has occurred (step 106). Notably, this error occurred in the filesystem operation after the pertinent inode was updated. Because this is an error that the OS (or other program) cannot correct immediately, the filesystem operation is aborted or terminated (step 108). The OS marks this filesystem as “dirty” and notifies a user with an alert message that an error has occurred (step 110). If so desired, the user can then initiate an error correction program (e.g., fsck) to determine the problem and correct the error (step 112).

A major drawback of this conventional solution is that since an inode was updated before an error occurred, aborting the filesystem operation at the point shown in FIG. 1 has left the filesystem in an inconsistent or in-between state as a result of the incomplete operation. Consequently, the data in the filesystem remains unavailable for use until the operational problem can be determined and the error corrected. If this data is important, this delay can be expensive to a user in terms of both time and money.

Thus, it would be advantageous to have a method by which a filesystem's state is not left inconsistent as a result of an aborted or otherwise incomplete filesystem operation.

### SUMMARY OF THE INVENTION

The present invention provides a method, apparatus, and computer instructions to bind “undo” information to given filesystem resources, in order to reverse or rollback certain changes and thereby return a filesystem affected by a failed or incomplete operation from an inconsistent state to a previous, consistent state. The present invention also provides a method, apparatus, and computer instructions to bind “undo” information to given filesystem resources so that that later changes to the metadata in the filesystem can be “undone,” by ensuring that no filesystem operation is successful until all preceding operations that changed the same metadata are also successful.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a flowchart showing the prior art flow for handling filesystem operation failures;

FIG. 2 depicts a pictorial representation of a network of data processing systems in which the present invention may be implemented;

FIG. 3 depicts a block diagram of a data processing system that may be implemented as a server in accordance with a preferred embodiment of the present invention;

FIG. 4 is a flowchart showing a flow for handling a filesystem operation failure according to an exemplary embodiment of the present invention; and

FIG. 5 is a flowchart showing an alternate flow for handling a filesystem operation failure according to an exemplary embodiment of the present invention.

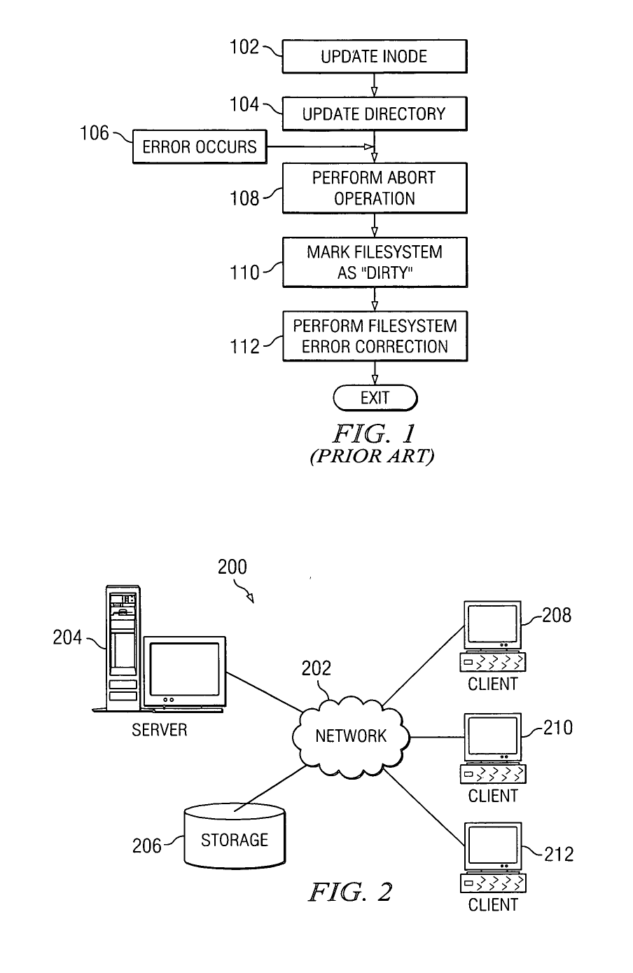

### DETAILED DESCRIPTION OF THE PREFERRED EMBODIMENT

With reference now to the figures, FIG. 2 depicts a pictorial representation of a network of data processing systems in which the present invention may be implemented. Network data processing system 200 is a network of computers in which the present invention may be implemented. Network data processing system 200 contains a network 202, which is the medium used to provide communication links between various devices and computers connected together within network data processing system 200. Network 202 may include connections, such as wire, wireless communication links, or fiber optic cables.

In the depicted example, server 204 is connected to network 202 along with storage unit 206. In addition, clients 208, 210, and 212 are connected to network 202. These clients 208, 210, and 212 may be, for example, personal computers or network computers. In the depicted example, server 204 provides data, such as boot files, operating system images, and applications to clients 208-212. Clients 208, 210, and 212 are clients to server 204. Network data processing system 200 may include additional servers, clients, and other devices not shown. In the depicted example, network data processing system 200 is the Internet with network 202 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 200 also may be implemented as a number of different types of networks, such as for example, an intranet, a local area network (LAN), or a wide area network (WAN). FIG. 2 is intended as an example, and not as an architectural limitation for the present invention.

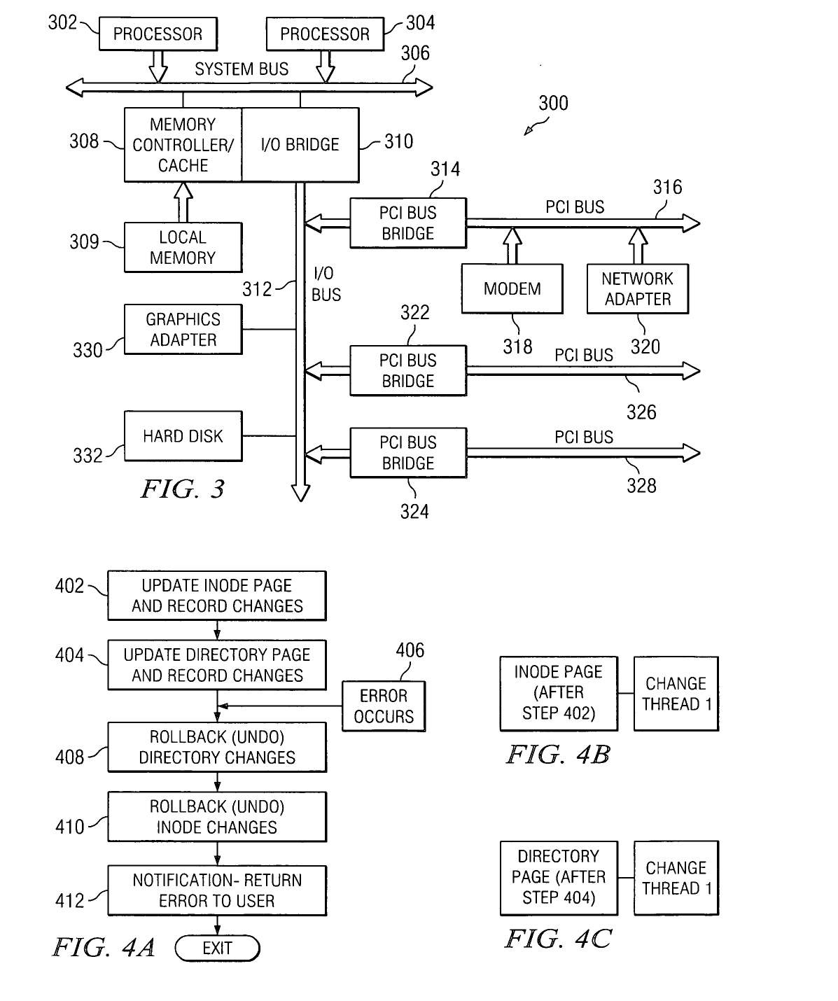

Referring to FIG. 3, a block diagram of a data processing system that may be implemented as a server, such as server 204 in FIG. 2, is depicted in accordance with a preferred embodiment of the present invention. Data processing system 300 may be a symmetric multiprocessor (SMP) system including a plurality of processors 302 and 304 connected to system bus 306. Alternatively, a single processor system may be employed. Also connected to system bus 306 is memory controller/cache 308, which provides an interface to local memory 309. I/O bus bridge 310 is connected to system bus 306 and provides an interface to I/O bus 312. Memory controller/cache 308 and I/O bus bridge 310 may be integrated as depicted.

Peripheral component interconnect (PCI) bus bridge 314 connected to I/O bus 312 provides an interface to PCI local bus 316. A number of modems may be connected to PCI local bus 316. Typical PCI bus implementations will support four PCI expansion slots or add-in connectors. Communications links to clients 208-212 in FIG. 2 may be provided through modem 318 and network adapter 320 connected to PCI local bus 316 through add-in boards.

Additional PCI bus bridges 322 and 324 provide interfaces for additional PCI local buses 326 and 328, from which additional modems or network adapters may be supported. In this manner, data processing system 300 allows connections to multiple network computers. A memory-mapped graphics adapter 330 and hard disk 332 may also be connected to I/O bus 312 as depicted, either directly or indirectly.

Those of ordinary skill in the art will appreciate that the hardware depicted in FIG. 3 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 3 may be, for example, an IBM eServer pSeries system, a product of International Business Machines Corporation in Armonk, N.Y., running the Advanced Interactive Executive (AIX) OS, LINUX OS, or any other appropriate OS.

Essentially, in accordance with an exemplary embodiment of the present invention, as each resource (e.g., data file) is acquired by a filesystem operation and the resource's data modified or changed, the filesystem operation stores “undo” information for that resource that can be used to reverse the changes. Also, the filesystem operation determines if other “undo” information is present for that resource, before the operation adds its own “undo” information. The filesystem operation determines, if any, which threads created the other “undo” information. As such, the filesystem operation considers the other “undo” information as “uncommitted updates” and that the other threads' operations are not yet complete.

In a “normal” or “non-error” path (e.g., no filesystem operation error has occurred), the filesystem operation modifies or changes all of the pertinent resources (data files), completes the entire operation, and then remains in a wait state. At this point, the filesystem operation waits for all other threads that had uncommitted updates on the resources involved. The filesystem operation allows all of the other threads to complete their operations successfully, before the filesystem operation can commit to the use of its undo information (thereby removing the changes that were made by the filesystem operation).

After the other threads have committed and used their undo information successfully, the filesystem operation, for the thread being run, can remove all of the undo blocked information for its resources, and then “wake up” any of the other threads that are waiting for the filesystem operation to be completed. Notably, in accordance with the present invention, if a deadlock situation occurs whereby two resources are modified in different orders, but both modifications are successful, both sets of undo blocks can be removed.

If an error occurs during the filesystem operation, the filesystem can review each resource that it has modified and determine if other threads have also modified resources in addition to the filesystem's initial modifications. If such other modifications are found, the threads that performed these modifications are considered to be in a wait state and waiting for the particular thread's operation that failed (due to the error involved). The failed thread then notifies the later (in time) threads that an operation has failed and all modifications that the other threads made are to be “undone”. Each thread is then run and all metadata changes are “undone”. The failed thread can wait for a repair process or an input/output command to complete its operation. Thus, the failed thread and the other threads have returned the filesystem to a previous, consistent state.

Specifically, FIGS. 4A-4C depict a flow showing the handling of a filesystem operation failure according to an exemplary embodiment of the present invention. In this exemplary embodiment, the filesystem can be located, for example, on hard disk 332 of FIG. 3, and the filesystem operation shown can be, for example, a file removal or unlinking operation being executed by a LINUX or AIX OS. Referring to FIG. 4A, in this exemplary method, the flowchart is entered during a filesystem operation when the filesystem is updating an inode page (file data) for a file (step 402). For example, at step 402, the filesystem changes the object-specific data in the inode page for a particular thread associated with the file of interest (e.g., time of operation, regular file, etc.) and records the changes that were made. The filesystem can store the recorded changes, for example, on hard disk 332 of FIG. 3. FIG. 4B illustrates an exemplary change made to a thread (e.g., thread 1) in the inode page for the file of interest, after the completion of step 402.

Next, the filesystem then updates a directory associated with the file of interest (step 404). An exemplary directory can be for an inverted tree structure. For example, at step 404, the filesystem changes certain data in the directory page for the thread described above with respect to step 402, and records the changes made. For a file removal operation, the directory change may be the deletion of the previous entry. The filesystem can store the recorded changes, for example, on hard disk 332 of FIG. 3. FIG. 4C illustrates an exemplary change made to a thread (e.g., thread 1) in the directory page associated with the file of interest, after the completion of step 404.

After the update and record change occurs, it is assumed that an error has occurred in the filesystem operation shown (step 406). In accordance with the present invention, the filesystem retrieves (e.g., from hard disk 332 of FIG. 3) the stored changes made to the data in the updated directory, and reverses those changes using, for example, an “undo” command (step 408). For example, the previously deleted entry is restored to the directory page. Similarly, the filesystem retrieves the stored changes made to the file data in the updated inode, and reverses those changes also using, for example, an “undo” command (step 410). Notably, at this point, the filesystem has been returned to a consistent state. As a result, the data in the filesystem is again available for use even if the operational problem has not been corrected. The filesystem can send an error message to the user, in order to alert the user to the operational problem that has occurred (step 412). At this point, the filesystem is “clean”.

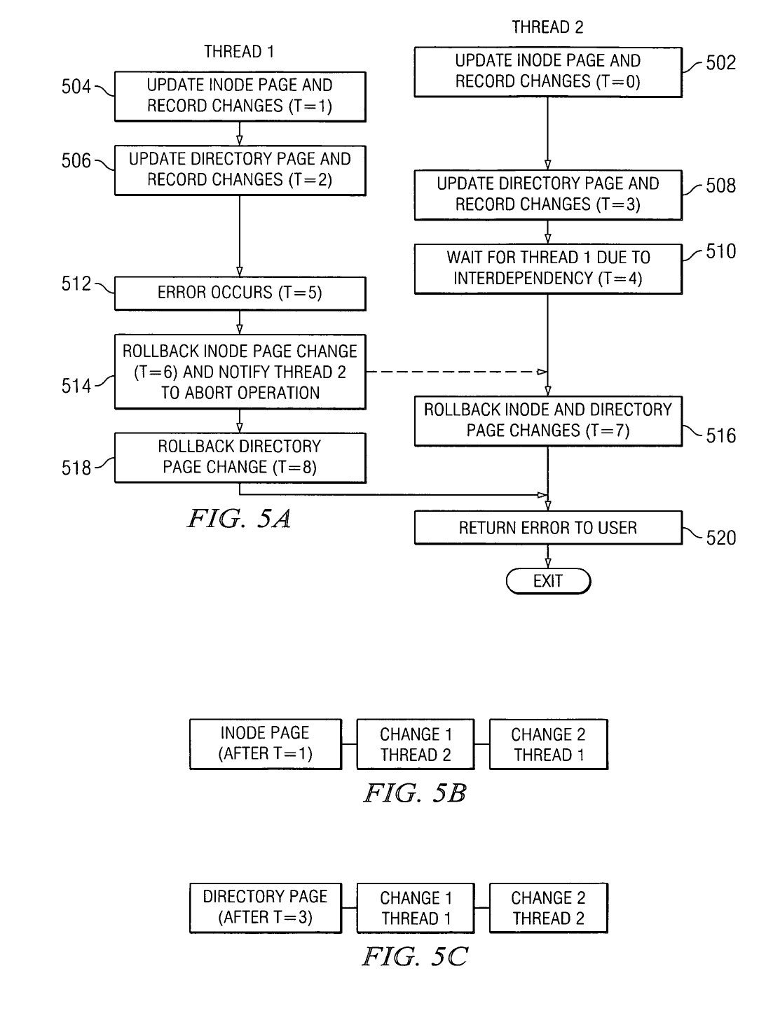

FIGS. 5A-5C depict an alternative flow showing the handling of a filesystem operation failure according to an exemplary embodiment of the present invention. In this exemplary embodiment, the filesystem operation shown is a multi-thread operation, instead of the exemplary single thread operation described above with respect to FIGS. 4A-4C. Also, similar to the filesystem described above with respect to FIGS. 4A-4C, the filesystem associated with FIGS. 5A-5C can be located, for example, on hard disk 332 of FIG. 3, and the filesystem operation shown can be, for example, a file removal or unlinking operation being executed by a LINUX or AIX OS.

Essentially, the exemplary embodiment of FIGS. 5A-5C provides a method for ensuring that later changes to a filesystem can be “undone” so as to return a filesystem to a consistent state, by ensuring that no operation is fully successful until the preceding operations that changed the same metadata are also successful. If a filesystem operation error has occurred, the filesystem operation can review every resource that the filesystem has changed to determine if other threads have modified data in addition to the initial changes. A failing thread notifies other threads that a filesystem operation has failed and all previous changes need to be “undone”. Each of the other threads then continues its operation and “undoes” all pertinent metadata changes. Thus, the filesystem is “clean” and returned to a previous, consistent state.

Specifically, referring to FIG. 5A, in this exemplary method, the flowchart is entered during a filesystem operation when the filesystem is updating an inode page with data for a file associated with a particular thread (step 502). The relative timing of the exemplary steps in the filesystem operation of FIG. 5A is denoted by T=0, 1, 2, 3, . . . 8 as shown in an example timing unit for T. For example, at T=0, the filesystem changes the object-specific data in the inode page for thread 2 for the file of interest (e.g., time stamp for the operation, regular file, etc.) and records the changes made (step 502). The filesystem can store the recorded changes, for example, on hard disk 332 of FIG. 3. At T=1, the filesystem changes the object-specific data in the inode page with data for thread 1 associated with the file of interest (e.g., time stamp for the operation, regular file, etc.), and records or stores the changes made (step 504). Since there is already a changed record from thread 2, the changes to the inode page for thread 1 are chained to the end of those from thread 2. FIG. 5B illustrates exemplary changes made to the data associated with the threads (e.g., threads 1 and 2) in the inode page of the file of interest, after the completion of step 504 (T=1).

At T=2, the filesystem changes certain data in the directory page for thread 1 for the file of interest, and records or stores the changes made (step 506). At T=3, the filesystem also changes the data in the directory page for thread 2 for the file of interest, and records or stores the changes made (step 508). Since there is already a changed record from thread 1, the changes to the directory page for thread 2 are chained to the end of those from thread 1. For example, FIG. 5C illustrates the exemplary changes 1 and 2 made to the data associated with threads 1 and 2 in the directory page for the file of interest, after the completion of step 508 (T=3).

At T=4, because of the interdependency of the files associated with the operations being performed for both threads 1 and 2, the filesystem delays the timing of the operations for thread 2 until the operations for thread 1 are appropriately synchronized with those of thread 2 (step 510). Specifically, thread 2 reviews its changes that were made, and also determines that thread 1 had made at least one change prior to those of thread 2. Consequently, thread 2 is required to wait for thread 1 to complete its operations before thread 2 can continue its operations, because thread 1 may want to request thread 2 to abort its operations.

After the update and record changes occur, at T=5, it is assumed that an error has occurred with respect to thread 1 in the filesystem operations shown (step 512). In accordance with the present invention, at T=6, the filesystem retrieves (e.g., from hard disk 332 of FIG. 3) the stored changes made to the data in the updated inode page for thread 1, and attempts to reverse those changes using, for example, an “undo” command (step 514). Notably, thread 1 attempts to rollback these changes as much as possible. However, the only “outer level” change thread 1 can make is to rollback the changes that were made to the inode page. Thread 1 notifies thread 2 to abort its filesystem operations (step 514).

Similarly, at T=7, the filesystem retrieves the stored changes made to the data in the updated inode page and directory page for thread 2, and reverses those changes using, for example, an “undo” command (step 516). Specifically, thread 2 aborts both changes, because now both of the thread 2 changes are “outer level” changes. Also, at T=8, the filesystem retrieves the stored changes made to the data in the updated directory page for thread 1, and reverses those changes again using, for example, an “undo” command (step 518).

Notably, at this point, the filesystem depicted in FIGS. 5A-5C has been returned to a consistent state. As a result, the data in the filesystem is again available for use even if the operational problem (step 512) has not been corrected. Finally, both threads 1 and 2 send an error message to the user, in order to alert the user to the operational problem that has occurred (step 520). At this point, the filesystem is “clean”.

It is important to note that although an “undo” command is described above as being used to rollback or reverse changes that have been made during the filesystem operations, the present invention is not intended to be so limited. Other appropriate commands, instructions or processes may be used to rollback or reverse such changes, in order to return a filesystem to a consistent state, and still be covered by the present invention.

It is also important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A system for recovering from a filesystem operation failure, comprising:
a processor;
a filesystem coupled to said processor; and
a set of instructions configured to run on said processor, said set of instructions operable to:
change a first set of data for a first thread associated with a first file of said filesystem;
store said change for said first set of data;
responsive to an operation error, retrieve said stored change for said first set of data; and
rollback said change to said first set of data to recover said first set of data for said first thread.

2. The system of claim 1, wherein said set of instructions are further operable to:
change a second set of data for a second thread, said second thread associated with a second file of said filesystem;
store said change for said second set of data;
responsive to said operation error, retrieve said stored change for said second set of data; and
rollback said change to said second set of data to recover said second set of data for said second thread.

3. The system of claim 2, wherein the retrieve and rollback operations are responsive to a notification from said first thread.

4. The system of claim 1, wherein said operation error comprises a filesystem operation error.

5. The system of claim 1, wherein said operation error comprises a thread operation error.

6. The system of claim 1, wherein said first file comprises an inode page.

7. The system of claim 2, wherein said second file comprises a directory page.

8. A method of recovering from a filesystem operation failure, comprising the steps of:
changing a first set of data for a first thread associated with a first file of said filesystem;
storing said change for said first set of data;
responsive to an operation error, retrieving said stored change for said first set of data; and
rolling back said change to said first set of data to recover said first set of data for said first thread.

9. The method of claim 8, further comprising the steps of:
changing a second set of data for a second thread, said second thread associated with a second file of said filesystem;
storing said change for said second set of data;
responsive to said operation error, retrieving said stored change for said second set of data; and
rolling back said change to said second set of data to recover said second set of data for said second thread.

10. The method of claim 9, wherein the retrieving and rolling back steps are responsive to a notification from said first thread.

11. The method of claim 8, wherein said operation error comprises a filesystem operation error.

12. The method of claim 8, wherein said operation error comprises a thread operation error.

13. The method of claim 9, wherein said operation error comprises a multi-thread operation error.

14. The method of claim 8, wherein said first file comprises an mode page.

15. The method of claim 9, wherein said second file comprises a directory page.

16. A computer program product on a computer readable medium, said computer program product comprising:
first instructions for changing a first set of data for a first thread associated with a first file of a filesystem;
second instructions for storing said change for said first set of data;
third instructions for receiving information about an operation error;
responsive to said third instructions, fourth instructions for retrieving said stored change for said first set of data; and
fifth instructions for rolling back said change to said first set of data to recover said first set of data for said first thread.

17. The computer program product of claim 16, further comprising:
sixth instructions for changing a second set of data for a second thread, said second thread associated with a second file of said filesystem;
seventh instructions for storing said change for said second set of data;
responsive to said third instructions, eighth instructions for retrieving said stored change for said second set of data; and
ninth instructions for rolling back said change to said second set of data to recover said second set of data for said second thread.

18. The computer program product of claim 16, wherein the eighth and ninth instructions are responsive to a notification from said first thread.

19. The computer program product of claim 16, wherein said operation error comprises a filesystem operation error.

20. The computer program product of claim 16, wherein said operation error comprises a thread operation error.
